(19) United States
(12) Patent Application Publication
(10) Pub. No.: US 2012/0319360 A1
(43) Pub. Date: Dec. 20, 2012

(54) PLUG ASSEMBLY FOR BLADE OUTER AIR SEAL

(76) Inventors: Ken F. Blaney, Middleton, NH (US); Paul M. Lutjen, Kennebunkport, ME (US)

(21) Appl. No.: 13/163,929

(22) Filed: Jun. 20, 2011

(51) Int. Cl. F16J 15/02; B23P 11/00

(52) U.S. Cl. 277/590; 29/428

(57) ABSTRACT

A plug assembly includes a cup which defines a cup portion and a cup anti-liberation portion along an axis, a wedge is mountable within the cup portion to at least partially radially expand the cup anti-liberation portion.

### BACKGROUND

The present application relates to a plug assembly and more particularly to a blade outer air seal (BOAS).

Gas turbine engines generally include fan, compressor, combustor and turbine sections positioned along an engine axis of rotation. The fan, compressor, and turbine sections each include a series of stator and rotor blade assemblies. A rotor and an axially adjacent array of stator assemblies may be referred to as a stage. Each stator vane assembly increases efficiency through the direction of core gas flow into or out of the rotor assemblies.

An outer case may include a multiple of blade outer air seal (BOAS) segments which provide an outer radial flow path boundary for the core gas to accommodate thermal and dynamic variation. The BOAS segments are subjected to relatively high temperatures and often receive a secondary cooling airflow for temperature control.

The BOAS segments may be cast via an investment casting process. In an exemplary casting process, a ceramic casting core defines core legs which extend between edges of the core. The core is placed in a die and wax is molded in the die to form a pattern. The pattern may be shelled, e.g., a stuccoing process to form a ceramic shell, then the wax removed from the shell. Metal is cast in the shell over the core then the shell and core are destructively removed. After core removal, the core legs form as-cast passageways open at both edges of the raw BOAS segment casting. At least some of these core run-out passageways are closed via plug welding or braze pins. Air inlets and outlets to the passageways may then be drilled.

### SUMMARY

A plug assembly according to an exemplary aspect of the present disclosure includes a cup which defines a cup portion and a cup anti-liberation portion along an axis. A wedge mountable within the cup portion to at least partially radially expand the cup anti-liberation portion.

A component according to an exemplary aspect of the present disclosure includes a bore which defines a bore portion and a bore anti-liberation portion along an axis. A cup which defines a cup portion and a cup anti-liberation portion. A wedge mountable within the cup portion to engage the cup anti-liberation portion with the bore anti-liberation portion.

A method of plugging an opening according to an exemplary aspect of the present disclosure includes pressing a wedge into a cup to at least partially radially expand a cup anti-liberation portion and engage the cup anti-liberation portion with a bore anti-liberation portion.

### BRIEF DESCRIPTION OF THE DRAWINGS

The various features and advantages of this invention will become apparent to those skilled in the art from the following detailed description of the disclosed non-limiting embodiment. The drawings that accompany the detailed description can be briefly described as follows:

FIG. 1 is a general sectional diagrammatic view of a gas turbine engine HPT section;

FIG. 2 is a sectional view of a BOAS segment;

FIG. 3 is a sectional view of the BOAS segment;

FIG. 4 is an exploded perspective view of the BOAS segment with a plug assembly therefor;

FIG. 5 is an exploded side view of the BOAS segment with a plug assembly therefor;

FIG. 6 is a partial exploded side view of the plug assembly;

FIG. 7 is a side view of the plug assembly in an assembled condition;

FIG. 8 is an exploded side view of another non-limiting embodiment of a plug assembly;

FIG. 9 is an exploded side view of another non-limiting embodiment of a plug assembly;

FIG. 10 is an exploded side view of another non-limiting embodiment of a plug assembly;

FIG. 11 is a side view of the plug assembly of FIG. 11 in an assembled condition.

### DETAILED DESCRIPTION OF THE DISCLOSED EMBODIMENT

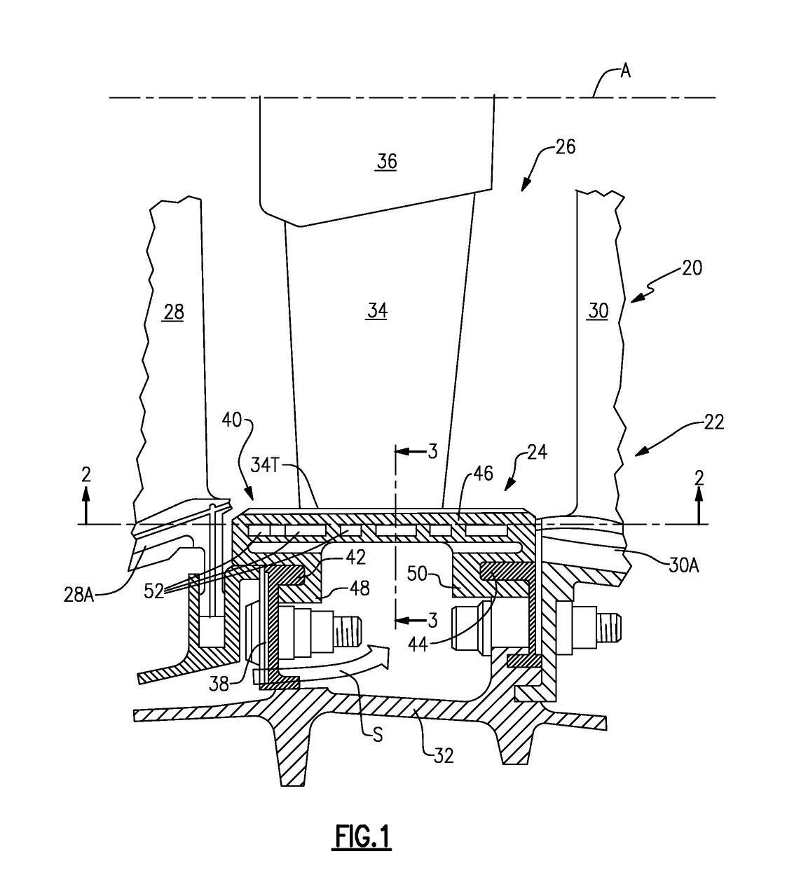

FIG. 1 schematically illustrates a gas turbine engine 20, illustrated partially as a High Pressure Turbine HPT section 22 disposed along a common engine longitudinal axis A. The engine 20 includes a Blade Outer Air Seal (BOAS) assembly 24 to provide an outer core gas path seal for the turbine section 22. It should be understood that although a BOAS assembly for a HPT is disclosed in the illustrated embodiment, the BOAS assembly may be utilized in any section of a gas turbine engine. The BOAS segment may find beneficial use in many industries including aerospace, industrial, electricity generation, naval propulsion, pumping sets for gas and oil transmission, aircraft propulsion, vehicle engines, and stationary power plants.

The turbine section 22 includes a rotor assembly 26 disposed between forward 28 and aft 30 stationary vane assemblies. Outer vane supports 28A, 30A attach the respective vane assemblies to an engine case 32. The rotor assembly 26 includes a plurality of airfoils 34 circumferentially disposed around a disk 36. The distal end of each airfoil 34 may be referred to as the blade tip 34T which rides adjacent to the BOAS assembly 24.

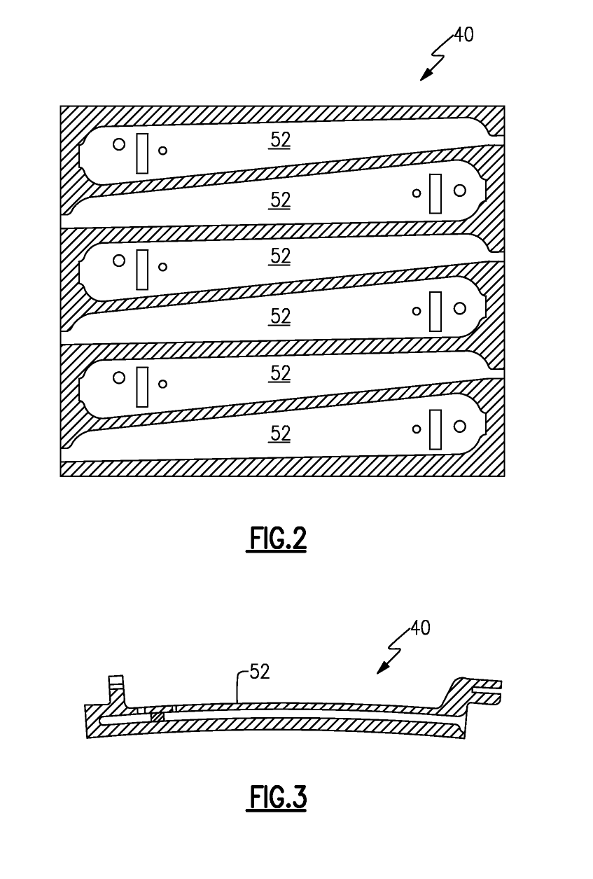

The BOAS assembly 24 is disposed in an annulus radially between the engine case 32 and the blade tips 34T. The BOAS assembly 24 generally includes a blade outer air seal (BOAS) support 38 and a multiple of blade outer air seal (BOAS) segments 40 mountable thereto (FIGS. 2 and 3). The BOAS support 38 is mounted within the engine case 32 to define forward and aft flanges 42, 44 to receive the BOAS segments 40. The forward flanges 42 and the aft flanges 44 may be circumferentially segmented to receive the BOAS segments 40 in a circumferentially rotated and locked arrangement as generally understood. It should be understood that various interfaces may alternatively be provided.

Each BOAS segment 40 includes a body 46 which defines a forward interface 48 and an aft interface 50. The forward interface 48 and the aft interface 50 respectively engage the flanges 42, 44 to secure each individual BOAS segment 40 thereto.

Each BOAS segment 40 includes one or more cavities 52 to receive a secondary cooling airflow S. It should be understood that various alternative cavity and passageway arrangements may be provided. Each cavity 52 may be formed through, for example, an investment casting process.

With reference to FIG. 4, the investment casting process typically requires one or more core run out openings 60 be plugged with a plug assembly 62 to assure performance of the BOAS segment 40. It should be understood that although the plug assembly 62 is used to the plug the core run out opening 60 of a BOAS segment 40, the plug assembly 62 may be utilized in various other components.

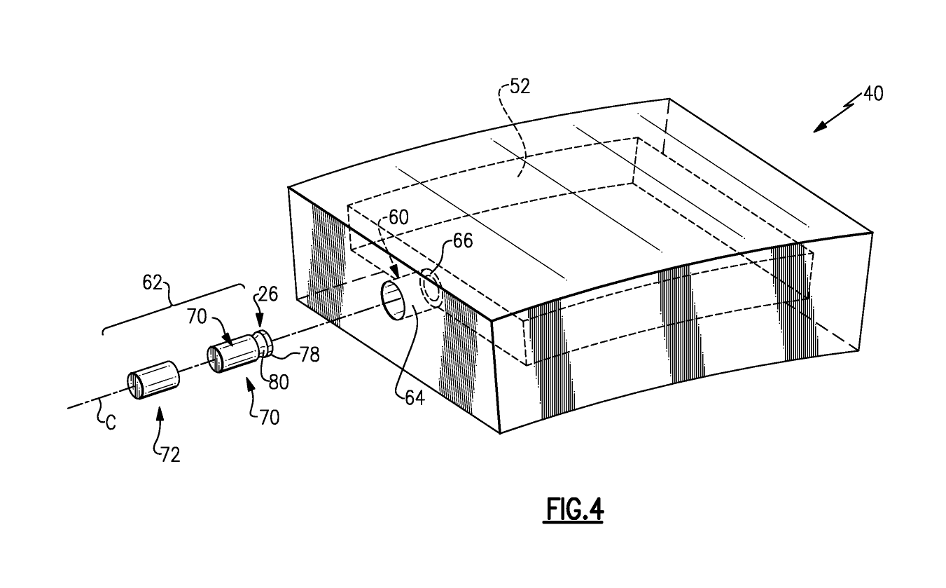

The core run-out opening 60 generally includes a bore portion 64 and a bore anti-liberation portion 66. The bore anti-liberation portion 66 in the disclosed non-limiting embodiment, is a reduced diameter portion adjacent to the innermost section of the bore portion 64. In the disclosed, non-limiting embodiment, the bore anti-liberation portion 66 includes a radially inward directed shoulder 68 (also illustrated in FIG. 5).

The plug assembly 62 generally includes a cup 70 and a wedge 72. The cup 70 is inserted along an axis C of the as-cast core run out opening 60. The cup 70 includes a cup portion 74 and a cup anti-liberation portion 76 at an end section thereof. The cup anti-liberation portion 76 in the disclosed non-limiting embodiment may include a first reduced diameter portion 78 and a second reduced diameter portion 80. The first reduced diameter portion 78 and the second reduced diameter portion 80 define a diameter smaller than the cup portion 74. The first reduced diameter portion 78 defines a closed end section of the cup 70 and defines a diameter greater than the second reduced diameter portion 80. That is, the second reduced diameter portion 80 is the smallest diameter and is axially located generally in line with the radially inward directed shoulder 68.

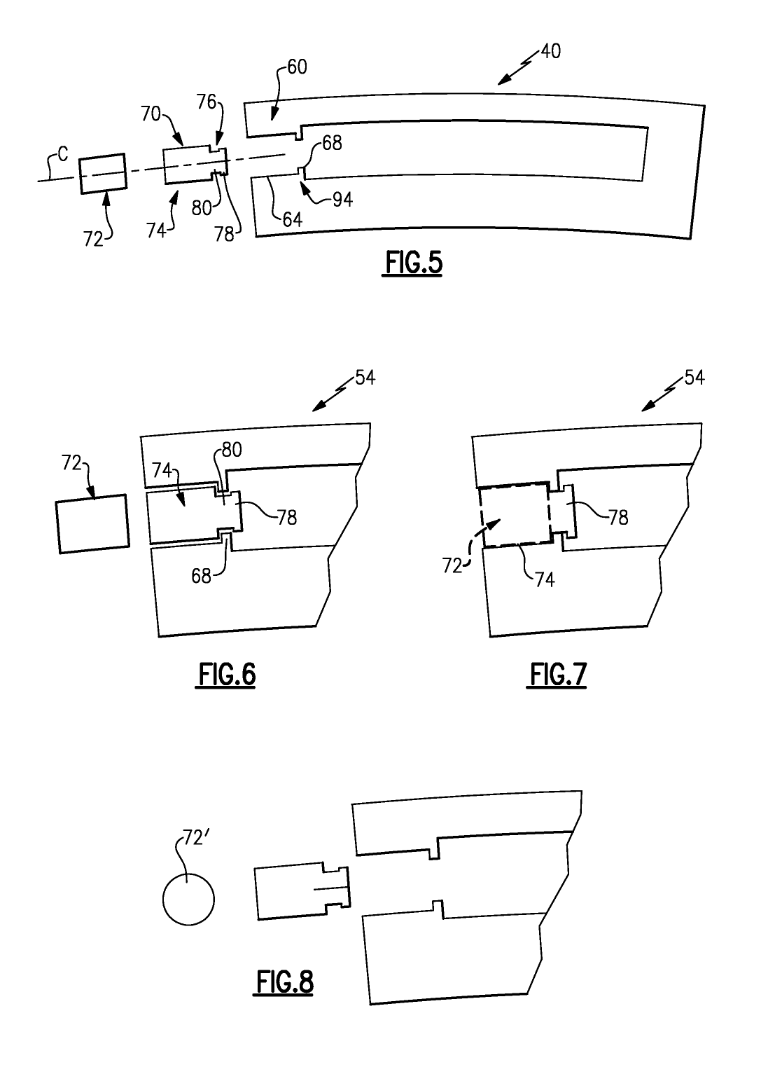

With reference to FIG. 6, once the cup 70 is located into the core run-out opening 60 such that the cup portion 74 abuts the radially inward directed shoulder 68 and the second reduced diameter portion 80 is axially located generally in line with the radially inward directed shoulder 68, the wedge 72 is pressed into the cup 70. As the wedge 72 is pressed into the cup 70, the wedge 72 expands the cup 70 into a press fit with the bore portion 64 (FIG. 7). The wedge 72, when pressed into the cup 70, also expands the first reduced diameter portion 78 and the second reduced diameter portion 80 relative to the radially inward directed shoulder 68 such that the first reduced diameter portion 78 defines a diameter greater than the radially inward directed shoulder 68. The cup 70 is thereby further locked in place through the interaction of the cup anti-liberation portion 76 and the bore anti-liberation portion 66.

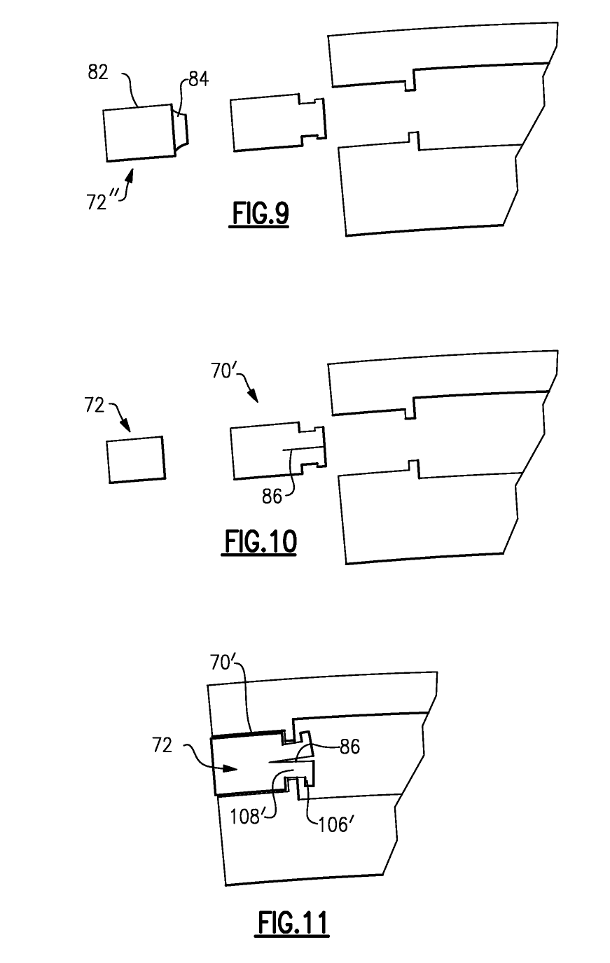

The wedge 72 may be of various shapes such as a pin shape to provide a flush fit with the core run out opening 60 or a ball shape wedge 72′ (FIG. 8) should a flush fit not be required. The wedge 72″ may additionally include a wedge body 82 and a protrusion 84 which facilities expansion of the first reduced diameter portion 78 and the second reduced diameter portion 80 (FIG. 9). The protrusion 84 extends from a distal end of the wedge body 82 but may define a lesser diameter than the wedge body 82. The protrusion 84 may be of various shapes such as cylindrical, bull nose, round nose, conical, frustro-conical, angular or other shape which facilities expansion of the first reduced diameter portion 78 and the second reduced diameter portion 80.

With reference to FIG. 10, an alternate non-limiting embodiment of the cup 70′ includes an axial slit 86 which extends at least partially along the length of the cup 70′. The axial slit 86 facilitates expansion of the first reduced diameter portion 78 and the second reduced diameter portion 80 of the cup 70′ (FIG. 11).

The plug assembly provides a consistent robust method which is less reliant on cleaning and surface preparation than brazing. The plug assembly is also less expensive since brazing/welding operation isn't required. Alternatively, brazing may be used as a redundant retention and need not be the primary retaining method. Without brazing, there is no need for heat treat which provides a quicker installation without need of a high proficiency worker. Moreover, the plug assembly may provide materials with higher temperature capability than with metallurgical bond.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A plug assembly comprising:
a cup which defines a cup portion and a cup anti-liberation portion along an axis; and
a wedge mountable within said cup portion to at least partially radially expand said cup anti-liberation portion.

2. The plug assembly as recited in claim 1, wherein said wedge is a pin.

3. The plug assembly as recited in claim 1, wherein said cup anti-liberation portion includes a first reduced diameter portion and a second reduced diameter portion which each define a diameter smaller than a diameter defined by said cup portion.

4. The plug assembly as recited in claim 3, wherein said first reduced diameter portion defines a closed end section of said cup.

5. The plug assembly as recited in claim 3, wherein said first reduced diameter portion defines a diameter greater than a diameter of said second reduced diameter portion.

6. The plug assembly as recited in claim 1, wherein said cup includes an axial slit.

7. The plug assembly as recited in claim 1, wherein said wedge includes a wedge body and a protrusion that extends from a distal end of said wedge body.

8. The plug assembly as recited in claim 1, wherein said wedge includes a wedge body and a wedge protrusion that extends from a distal end of said wedge body, said wedge protrusion defines a lesser diameter than said wedge body.

9. A component comprising:
a bore which defines a bore portion and a bore anti-liberation portion along an axis;
a cup which defines a cup portion and a cup anti-liberation portion; and
a wedge mountable within said cup portion to engage said cup anti-liberation portion with said bore anti-liberation portion.

10. The component as recited in claim 9, wherein said wedge is a pin, said pin flush with an end of said bore.

11. The component as recited in claim 9, wherein said cup anti-liberation portion includes a first reduced diameter portion and a second reduced diameter portion, said bore anti-liberation portion defines a radially inward directed shoulder, said second reduced diameter portion axially aligned with said radially inward directed shoulder.

12. The component as recited in claim 9, wherein said cup includes an axial slit.

13. The component as recited in claim 9, wherein said wedge includes a wedge body and a protrusion that extends from a distal end of said wedge body.

14. The component as recited in claim 9, wherein said wedge includes a wedge body and a protrusion that extends from a distal end of said wedge body, said protrusion defines a lesser diameter than said wedge body.

15. The component as recited in claim 9, wherein said bore is within a Blade Outer Air Seal (BOAS) segment.

16. A method of plugging an opening comprising:
pressing a wedge into a cup to at least partially radially expand a cup anti-liberation portion and engage the cup anti-liberation portion with a bore anti-liberation portion.

17. The method as recited in claim 16, further comprising forming a bore with a bore portion and the bore anti-liberation portion along an axis.

18. The method as recited in claim 17, further comprising pressing the wedge and the cup flush into the bore portion.

19. The method as recited in claim 17, further comprising pressing the wedge into the bore until a wedge body abuts a radially inward directed shoulder and a wedge protrusion axially extends at least partially beyond the radially inward directed shoulder.

20. The method as recited in claim 16, further comprising defining the cup to include a cup portion and the cup anti-liberation portion along an axis, the cup anti-liberation portion includes a first reduced diameter portion and a second reduced diameter portion, the bore anti-liberation portion defines a radially inward directed shoulder, the second reduced diameter portion axially aligned with the radially inward directed shoulder.
